(19) United States
(12) Patent Application Publication
(10) Pub. No.: US 2012/0176302 A1
(43) Pub. Date: Jul. 12, 2012

(54) OPTIMIZED ON-SCREEN KEYBOARD RESPONSIVE TO A USER'S THOUGHTS AND FACIAL EXPRESSIONS

(76) Inventors: Tomer MANGOUBI, Newton, MA (US); Nathan KASIMER, Sharon, MA (US); Samuel ROSENSTEIN, Newton, MA (US); Bram DIAMOND, Newton, MA (US)

(21) Appl. No.: 12/987,456

(22) Filed: Jan. 10, 2011

(51) Int. Cl. G09G 5/00

(52) U.S. Cl. 345/156

(57) ABSTRACT

A system and method that allows for control of an on-screen keyboard in response to brain activity input, even for those suffering from partial paralysis or locked-in syndrome. The system provides an on-screen keyboard arranged into blocks of keys for ease of navigation. In response to brain activity input, such as activity relating to thoughts or facial expressions, the system performs a variety of previously determined functions which control the on-screen keyboard. In response to the activity of the on-screen keyboard, the computer can be controlled in a manner similar to when using a standard hand-operated keyboard.

### FIELD OF THE DISCLOSURE

This disclosure relates to a system and method allowing users to navigate an on-screen keyboard by use of thoughts and facial expressions.

### BACKGROUND

Keyboards were one of the first devices used for direct human input into computers. Despite the development of alternative input technologies such as the mouse, touch screens and voice recognition, keyboards remain among the most commonly used and versatile devices for human to computer input. Keyboards are typically arranged in a standardized layout known as QWERTY, although other key-configurations are possible. Each key on the keyboard corresponds to a single written symbol, although simultaneous key presses can produce actions or computer commands. In response to a key press by the user, computer software processes the input by reporting the key press to the controlling software. Key presses are thus used to type text and numbers into word processors, web browsers, and other applications, while also allowing full or partial control of the computer's Operating System.

Many people have limited use of their hands, often due to paralysis. Further, people suffering from locked-in syndrome can usually move at most their eyes and some facial muscles, making communication very challenging. For such people, using a computer becomes difficult or impossible due to their inability to operate a mouse and keyboard. Prior attempts to address this issue, such as voice recognition software, could not accommodate sufferers of locked-in syndrome, as they were unable to speak.

Other attempts to address this problem utilized Electroencephalogram (“EEG”) headsets to translate brain activity into computer input. These EEG headsets, such as the Emotiv Epoc by Emotiv Systems and the Neural Impulse Actuator by OCZ Technology, are commercially available. Certain prior art systems allowed users to wear an input device, such as an Emotiv Epoc headset, which measures brain activity input in the form of EEG data. The EEG data is obtained by input device interface software, such as the EmoEngine Software by Emotiv Systems, resident in the computer memory. Together with the input device, the input device interface software converts the detected data into brain activity input. This brain activity input is available to other processes in communication with the input device interface software, such as the proprietary typing systems used for text entry. In this way, prior art systems could perform limited keyboard functions within their proprietary programs.

Some prior art EEG systems functioned by flashing a repeating sequence of characters on the screen, and then relying on the detection of a recognition signal to select said character while it is displayed to the user. These systems were not capable of replicating full keyboard functionality across all programs. Instead, non-standard, customized email or word processing software was necessary to receive user input, severely limiting a user's access to some of the most common computer programs, such as Microsoft Word. What is needed is an affordable system allowing control of a computer, even for those suffering from full paralysis or locked-in syndrome.

### SUMMARY

This disclosure relates to a computer system and method that provides for control of an on-screen keyboard, and in turn a computer system, in response to brain activity input. In some embodiments, this allows those suffering from partial paralysis, or even from locked-in syndrome, to operate a computer. The system provides an on-screen keyboard arranged into blocks of keys for ease of navigation. In response to brain activity input, such as activity relating to thoughts or facial expressions, the system performs a variety of previously determined functions which operate the on-screen keyboard. In response to the activity of the on-screen keyboard, the computer can be controlled in a manner similar to a standard hand-operated keyboard.

In an embodiment of the invention, an on-screen keyboard server interacts with the input device interface software to access the detected brain activity input. In accordance with the profile of the user wearing the input device, the on-screen keyboard server performs pre-defined functions that correspond to the measured brain activity input. Such pre-determined functions allow the user to navigate an on-screen keyboard in a manner similar to that of a traditional keyboard, allowing the user to control the computer operating system and to type text into any program of their choosing, without the use of a customized typing interface.

An on-screen keyboard server presents a keyboard that is divided into blocks of related keys, such as alphabetical keys, numerical keys, and other frequently used keys. The on-screen keyboard server can perform a wide variety of pre-determined functions in response to brain activity input. Such activities include pressing the currently highlighted key, moving between keys within a key block, moving between key blocks and directly entering full, pre-customized words in response to brain activity input. The on-screen keyboard server also allows the user to control the up, down, left and right arrow keys in response to brain activity input. By replicating full keyboard functionality a user can now directly control the computer operating system in response to brain activity input. Finally, pre-determined functions exist for automatically repeating any of the intra-block movement operations or arrow key operations until a pre-determined function is received to stop the intra-block movement.

### BRIEF DESCRIPTION OF THE DRAWINGS

FIG. 1 shows a system with an on-screen keyboard responsive to a user's thoughts and facial expressions, according to an embodiment of the invention.

FIG. 2 is a flow chart illustrating steps for controlling a computer via an on-screen keyboard responsive to brain activity input, according to an embodiment of the invention.

FIG. 3 shows a screen for selecting pre-determined functions and the brain activity input to which they are responsive, according to an embodiment of the invention.

FIG. 4 shows an on-screen keyboard arranged into a block of alphabetical keys, a block of numerical keys, and a block of frequent use keys, according to an embodiment of the invention.

FIG. 5 shows a screen for selecting custom words for frequent use, according to an embodiment of the invention.

FIG. 6 shows a screen for adjustable speed selection for automatic movement between keys, according to an embodiment of the invention.

### DETAILED DESCRIPTION

This disclosure relates to a computer system and method that provides for control of an on-screen keyboard, and in turn a computer system, in response to brain activity input. This allows those suffering from partial paralysis or even from locked-in syndrome, to operate a computer. As a benefit over prior art systems, the present invention provides an on-screen keyboard arranged into blocks of keys for ease of navigation. These blocks may represent, generally, alphabetical keys, numerical keys, and other frequently used keys. In response to brain activity input, such as activity relating to thoughts or facial expressions, the system performs a variety of previously determined functions which operate the on-screen keyboard. Although each of these functions facilitate and speed up the typing process, a user who is not skilled in manipulating input device 112 must control a minimum of only two of these functions to access the on-screen keyboard's full functionality. In response to the activity of the on-screen keyboard, the computer can be controlled in a manner similar to when using a standard hand-operated keyboard.

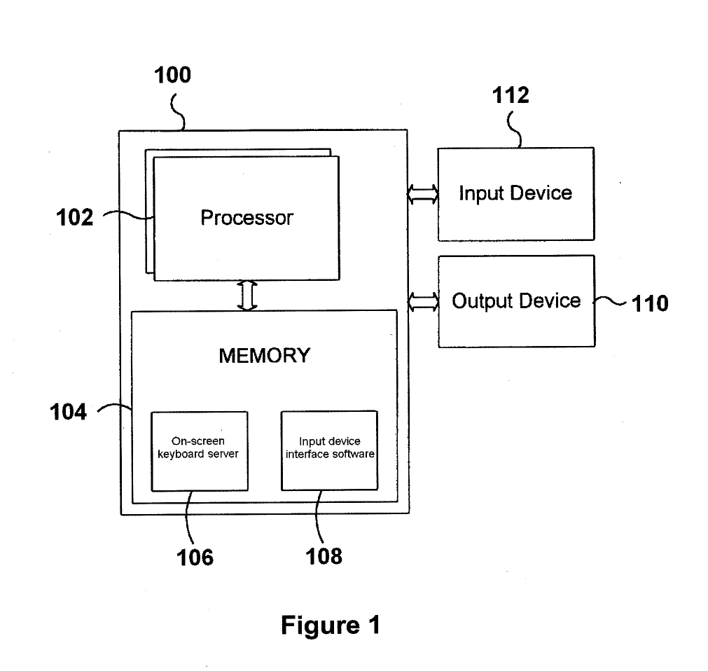

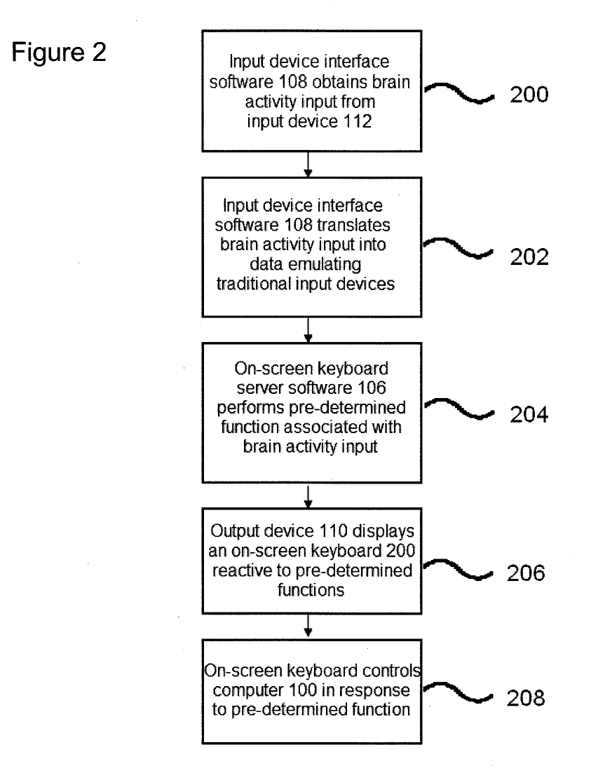

In FIG. 1, a computer 100 is shown as an embodiment of the present invention. The computer 100 includes a processor 102, a memory 104, on-screen keyboard server 106 and input device interface software 108. Computer 100 is connected to input device 112 via BlueTooth in some embodiments, although USB or other device connectivity interfaces may be used. Output device 110 is a monitor or other device capable of connecting to computer 100 and presenting graphical information to the user. On-screen keyboard server 106 and input device interface software 108 execute as processes resident in memory on computer 100. On-screen keyboard server 106 is responsive to input device interface software 108 and input device 112. On-screen keyboard server 106 also interacts with output device 110 to display an on-screen keyboard 200, as shown in FIG. 2. Input device 112 is, in some embodiments, an Emotiv Epoc electroencephalography (EEG) headset. Other embodiments may use, for example, the Neural Impulse Actuator by OCZ, the MindSet by Neurosky, or a variety of possible EEG headsets from BioSemi. Output device 112 is a display or other device capable of displaying on-screen keyboard 200 to the user wearing input device 112.

In some embodiments, input device 112 contains 14 electrodes and a two-axis gyro for measuring head rotation. The input device 112 measures brain activity input in the form of brain EEG data. The headset is capable of measuring four categories of input: (1) conscious thoughts; (2) emotions; (3) facial expressions; and (4) head rotation. The measured brain activity input is obtained by computer 100, and is processed by input device interface software 108. On-screen keyboard server 106 interacts with input device interface software 108 and output device 110 to display on-screen keyboard 200. On-screen keyboard 200 allows the user to control computer 100 in response to the measured brain activity input.

Input device 112 is in communication with computer 100 via an appropriate device driver, and in turn in connection with input device interface software 108. Through this connection, input device interface software 108 is able to obtain information about the user's thoughts or facial expressions in the form of EEG data. Proprietary algorithms provided with and running on input device 112 and input device interface software 108 work together to recognize specific types of facial expressions, emotions, or mental states. Input device interface software 108 utilizes a user profile containing pre-defined information specific to the user wearing input device 112, which allows for the personalization of detection results.

In some embodiments, input device interface software 108 translates the data obtained from input device 112 into data objects. Such data objects can include EmoEngine Event Objects, which alert the system to events such as new detection data being available, and EmoEngine State Objects, which contain the status of hardware and software outputs. These EmoState data objects represent brain activity input that can be accessed by applications running on computer 100 via appropriate API function calls. Such API function calls are well understood in the art. On-screen keyboard server 108 utilizes such function calls to communicate with input device interface software 108 and input device 112.

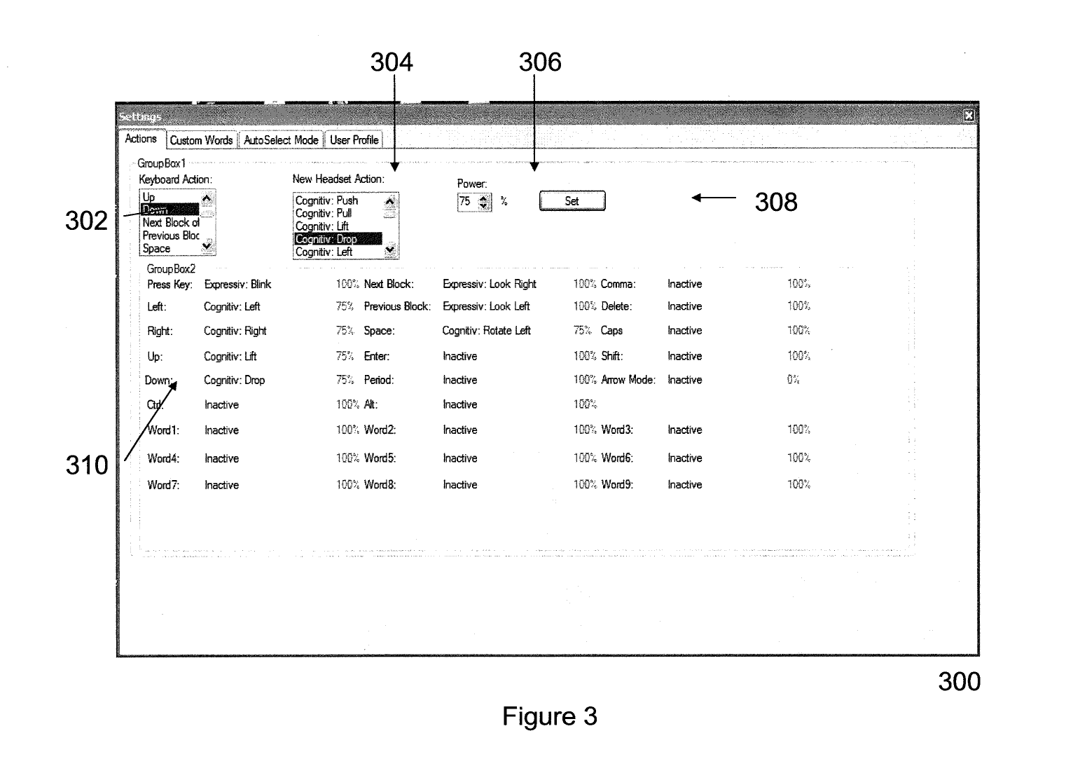

FIG. 2 is a flowchart illustrating steps of controlling a computer with brain activity input. In step 200, input device interface software 108 running on computer 100 communicates with input device 112 via any standard communication method known in the art. Input device 112 measures a user's EEG brain activity, and input device interface software 108 communicates with input device 112 to obtain this measured EEG data. For example, the user of the system may be thinking “Left.” Device interface software 108 obtains raw EEG data from input device 112. In Step 202, input device interface software 108 recognizes what type of brain activity input equates to a certain EEG input for the user as defined in their profile. Input device software 108 is trained, via a user's profile, to recognize what brain activity input equates to a certain EEG input to produce an electronic control signal. In the present example, the user's profile indicates that the measured EEG data equates to “Left.” These associations are shown in FIG. 3. Input device interface software 108 then translates this data into detected brain activity input data which is accessible by other software applications running on computer 100. This data is accessible via an API. In some embodiments, the EmoEngine API by Emotiv Systems is used. On-screen keyboard server 106 uses this API to interact with device interface software 108, and determines that the user is currently thinking “Left.” In step 404, the on-screen keyboard server 106 accesses the EmoState data objects created by input device interface software 108, which indicate that the user is thinking “Left.” In response, on-screen keyboard server 106 performs the pre-determined function associated with that brain activity input which, in the example, is to select the key to the left of the currently selected key.

FIG. 3 shows a configuration screen 300 for on-screen keyboard server 106. Item 302 lists possible pre-determined functions, and Item 304 lists possible brain activity inputs recognized by input device 112 and input device interface software 108. For example, Item 302 shows pre-determined functions for selecting the key above (Up), selecting the key below (Down), moving to the next key block (Next Block of Keys), moving to the previous key block (Previous Block of Keys), and so forth. Additionally, Item 304 gives example brain activity inputs of thinking “Push,” thinking “Pull,” thinking “Lift,” thinking “Drop,” and thinking “Left.” Item 310 shows relationships between the pre-determined function and the brain activity input. For example, selecting the currently highlighted key (Press Key) is performed whenever the user gives the mental command for his or her muscles to “Blink.” The system is configured for a user by selecting a pre-determined function 302 from a list of available functions, selecting a brain activity input 304 from a list of brain activity inputs, selecting a threshold error recognition level 306 for detected brain activity, and then clicking button 308. Error recognition level 306 allows the system to individually control the sensitivity of the system's measurements, in order to avoid erroneous performance (or lack thereof) of pre-determined functions. Through this process, brain activity input 304 can be correlated with a pre-determined function 302 in order to execute the pre-determined function whenever that brain activity input is detected. As shown in the present example, on-screen keyboard server 106 detects that the user is thinking “Left” and then selects the key to the left of the currently selected key. Not all pre-determined functions must be associated with a brain activity input. A user may choose to leave some functions inactive depending on proficiency with the input device. In some embodiments, the user must activate only two predetermined functions (“press key” and either “right” or “left”) to be able to type with the software, but may activate more to further customize the process.

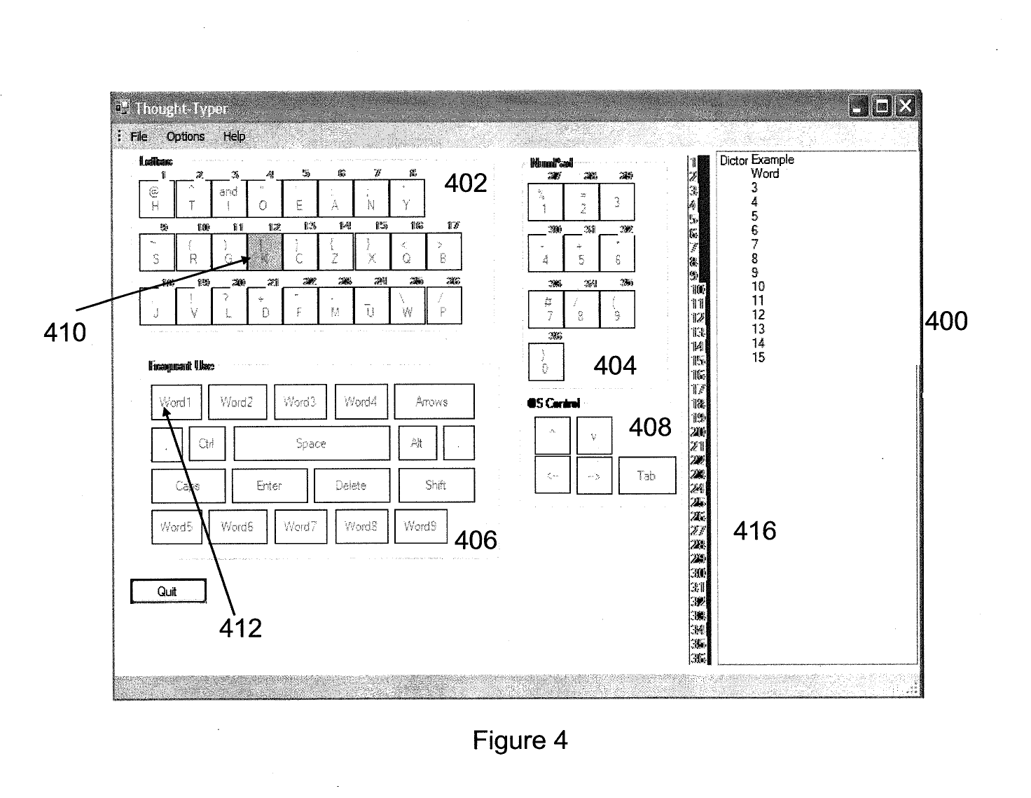

On-screen keyboard server 106 can perform a wide variety of pre-determined functions in response to brain activity input 304. In some embodiments, intra-key block pre-determined functions are available to press the currently highlighted key, to move to the key above the currently highlighted key, to move to the key below above the currently highlighted key, or to move to the key to the left or right of the currently highlighted key, within a key block 402-408 as shown in FIG. 4. In some embodiments, these movements can continue in a circular manner. So, for example, moving to the left from the left-most key can select the far-right key on that row, and moving up from the top row can select the corresponding key on the bottom row. In other embodiments the circular movement is relative to the entire block, so that moving to the left from the left-most key selects the far-right key on the row above, and moving to the right from the right-most key selects the far-left key on the row below the current row. This can be extended such that moving to the left from the left-most key on the top row selects the far-right key on the bottom row of a prior block of keys. For example, this could allow movement from the numerical “1” key in block 404 to the alphabetical “p” key in block 402, or from frequent use “word 1” in block 406 to the numerical “0” key in block 404. Similar movements can occur through movements to the right, up, or down from the appropriate corner of a block, to allow navigation of the entire keyboard with just a single directional movement and the “press key” function.

Further, pre-determined functions are also available to move among key blocks 402, 404, 406, and 408. In some embodiments, Next Key Block and Previous Key Block functions can be used to cycle through the key blocks, as shown in Item 310. In other embodiments, selecting a key block could be performed as a pre-determined function. For example, thinking “Look Right’ could select the Numerical key block. In this manner, a user can cease moving between alphabetical keys in key block 402 and begin moving between numerical keys in key block 404 in response to brain activity input. For example, a user drafting an email may primarily select keys within the alphabetical block. When the user needs to enter their phone number within the email, the user is able to move directly to the numerical keys by thinking “Look Right,” without having to move past all keys not of current interest.

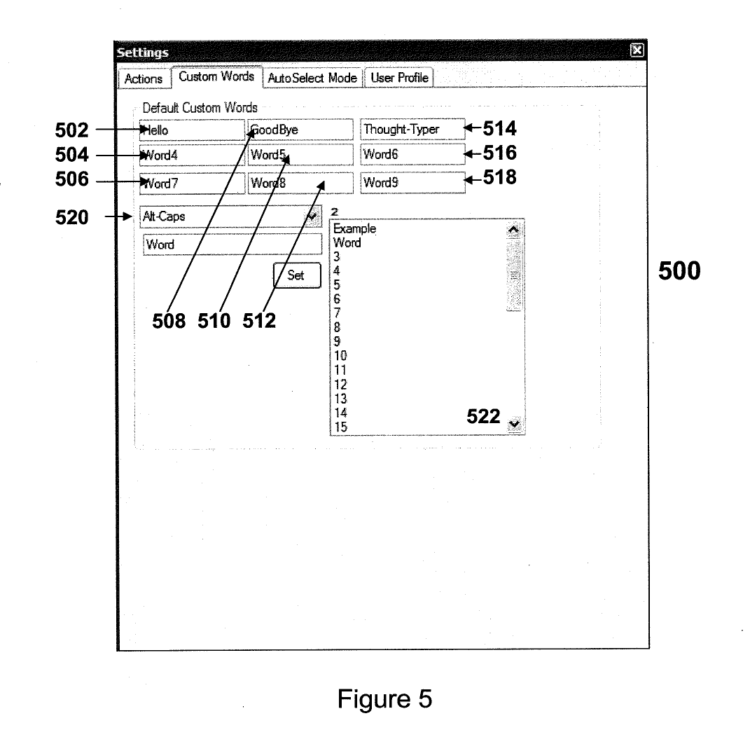

Any key in “frequent use” key block 406 may be directly associated with a brain activity input and need not be navigated to and clicked by means of using the up, down, left, right, or press-key functions. For instance, in example configuration 310, the spacebar key is set to be pressed whenever the user thinks “Rotate Left.” Because this feature eliminates the need to navigate to and from frequently used keys, it increases typing speed. Additionally, when the keys labeled “word 1”-“word 9” in key block 406 are clicked, a predetermined word of the user's choice will be entered in full. As an example, frequently used phrases such as the user's name or phone number can be entered as a group. The user may also configure certain key combinations (for instance, “ctrl-alt-g”), to type out full, predetermined words of their choice. A list of these words is displayed in Dictionary Display box 400 when a valid key combination is selected. For instance, if the Ctrl and Alt combination is selected, the Display box 400 will show all possible words that the Ctrl-Alt combination may produce depending on which key is selected to complete the combination. In an embodiment, the user may store up to 909 custom words. Configuring key combinations for custom words is shown in FIG. 5, item 520, discussed further below.

To function in a traditional keyboard manner, input device 112 would be required to detect “hold shift” and “press A” brain activity inputs simultaneously in order to capitalize the letter “A.” Performing a key combination such as “Ctrl-alt-a” would require 3 distinct brain activity inputs to be detected at once. Although input device 112 may be configured to detect up to four brain activity inputs at a time, it is often difficult for the user to train the device well enough to properly pick up more than one activity input at a single time. Thus, in order for all users to be able to easily replicate keyboard functionality, the Shift, Ctrl, and Alt keys presented in on-screen keyboard 400 are activated when clicked once and deactivated when clicked a second time. In other words, these keys now behave like the standard Caps Lock key on a normal keyboard, with the Caps Lock key being used to switch between uppercase and lowercase letters. This alteration obviates one traditional use of the shift key, which instead functions in the present invention to select the secondary character on the next pressed key. Similar to before, brain activity input pressing highlighted Item 410 would enter the key “k.” If the system detected brain activity input to activate shift before detecting brain activity input to press selected Item 410, the character “[” would be entered instead of “k.” Alphabetical keys which do not normally have secondary symbols are given secondary symbols to reduce the number of keys needed on the keyboard and hence cut down on navigation time. Were the virtual shift key to perform its standard function, it would behave exactly like the Caps Lock key and be redundant.

Further, predetermined functions allowing a user to control the directional arrow keys in block 408 as well as the Tab key in response to the brain-activity input usually associated with moving up, down, left, or right on the keyboard or between key blocks (using the Tab key) are activated when the user selects the “arrow” button in key block 408. Replacing these five distinct keys with a single arrow button gives the user the option to operate the arrow and tab keys intuitively, instead of having to select and press each one individually. Also, it allows the user to assign the brain activity inputs that would otherwise be dedicated to using the arrow plus tab keys to other frequent use keys. This maximizes the number of frequent use keys available and, by extension, the typing speed of the user. Thus, when a user wishes to navigate the operating system using these keys by selecting a program from a list of programs or a document from a list of documents, or if a user wishes to move up a line or over a character in a web page, a document, or email, or down a row in a spreadsheet, or perform other functions that the arrow keys on a keyboard usually perform, the user may perform the brain activity input to enter “arrow” mode (or select the Arrow Key block 408 as displayed in FIG. 3). The user then thinks the thought normally assigned to moving left, right, up, down or between key blocks and instead of performing their normally assigned keyboard functions, these thoughts will now replicate an arrow or tab keystroke. The user may return to typing by clicking the “arrow” button once more. Varying embodiments of the invention may use the “arrow” button in addition to or instead of the standard arrow keys. By replicating full keyboard functionality, a user can control the operating system of computer 100 in response to brain activity input.

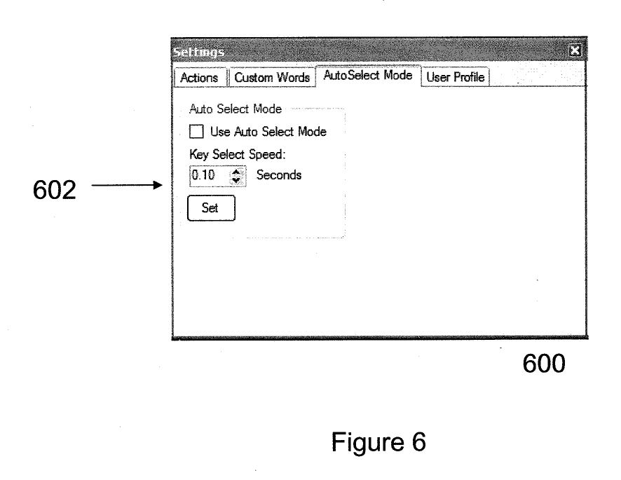

Finally, pre-determined functions exist for repeating any of the intra-block movement operations or arrow key operations until a pre-determined function is received to stop the intra-block movement. As an example, as shown in Item 410, the “k” key is currently selected. If the user wishes to next select the “s” key, it would otherwise require four distinct operations. First, the user must “think left” to select the “g,” key, then “think left” to select the “r” key, then again “think left” so select the “s” key, and finally “blink” to press the “s” key. By using a pre-determined function to repeat operations, the user can simply perform the brain activity input for repeatedly moving left, and perform the brain activity input to stop moving left when the “s” key is reached. FIG. 6 depicts a configuration screen 600 for on-screen keyboard server 106 where Item 602 determines the speed at which the automatic selection occurs. In order to accommodate different users' abilities or familiarity with the system, Item 602 selects the time in seconds that the auto key selection will wait while each key is selected, in order to give the user time to stop the auto selection process.

Through the use of on-screen keyboard 400, a user of input device 112 can control computer 100 without the need for specialized word processing, email, or other application software. On-screen keyboard server 106 provides key selection feedback to the user, in addition to allowing for control of the operating system of computer 100, or any programs executing thereon, such as Microsoft Word or Outlook. Therefore, the user does not need to use non-standard, customized word processing or other application software, and can enjoy access to the same computer programs as other computer users.

FIG. 4 is a screenshot of exemplary on-screen keyboard 400 as displayed by output device 110. On-screen keyboard 400 is organized into blocks of related keys. In some embodiments, on-screen keyboard 400 is organized into at least an alphabetical key block 402, a numerical key block 404, and frequent use key block 406. In alternate embodiments, other arrangements are possible, including an arrow key block 408. Alphabetical key block 402 contains alphabetical characters A-Z and punctuation keys, numerical key block 404 contains characters 0-9, and frequent use key block 406 contains frequently used keys and customized full words which can be entered with a single key press. Frequent use keys also allow for automatic key press combinations, such as selecting the crtl and “c” keys at the same time. Item 410 depicts the currently selected key, which is highlighted in a way to distinguish it from all other non-selected keys. Frequent use key block 406 contains, for example, the space key, enter key, ctrl key, alt key, period and comma keys, as well as custom words. An example of such custom word is shown as item 412. Custom word 412 could be set to automatically enter the phrase “Thank you,” or the user's mailing address, in response to a single brain activity input.

Custom word 412, and all other custom words, is configurable by the user of the system as shown in FIG. 5. FIG. 5 depicts a configuration screen 500 for on-screen keyboard server 106. Items 502-518 correspond to custom words Word1-Word9 as depicted in frequent use key block 406. These custom words can be specified individually for each user of the system, as shown in configuration screen 500. Custom words 502-518, therefore, allow a user to enter a complete phrase or series of characters in response to selecting a single key, such as custom word 502. Item 520 depicts a drop down box of common key combinations, such as Ctrl-Alt or Alt-Caps. Item 522 depicts a customizable list of words that can be assigned to each of these key combinations. For instance, the phrase “Word” is the second item on the list for the Alt-Caps combination. This means that when Alt and Caps are turned on and the “T” key in block 402 is pressed, the phrase “Word” will be typed out in full. Note that the “T” key is labeled with a “2” to indicate that it corresponds to the second word associated with the currently activated key combination. The list of words associated with the currently active key combination is displayed in list 416 as defined by Items 520 and 522 in FIG. 5.

Organizing the on-screen keyboard 400 into at least logical blocks 402, 404 and 406 allows a user to efficiently navigate between keys. Further, individual keys within each key block can be arranged near other keys which are frequently used together, rather than in the traditional QWERTY format. In this way, a user of the system can minimize the effort required to move between keys within a block, in order to more efficiently make character selections.

On-screen keyboard server 106 is provided in software. In an embodiment, it is written in Microsoft's Visual Basic.NET programming language. Those skilled in the art will understand that many such languages could be used without departing from the scope of the present invention. On-screen keyboard server 106 could be provided in wide array of mediums, such as on a disk, loaded onto a computer, downloaded from a network, or any other well known means of distributing software.

Although the present invention has been described and illustrated in the foregoing exemplary embodiments, it is understood that the present disclosure has been made only by way of example, and that numerous changes in the details of implementation of the invention may be made without departing from the spirit and scope of the invention, which is limited only by the claims that follow. Other embodiments are within the scope of following claims.

What is claimed is:

1. A method for using thoughts or facial expressions to operate a computer, the method comprising:
displaying on an on-screen keyboard a block of at least alphabetical keys, a block of at least numerical keys, and a block of at least frequent-use keys;
providing a group of functions for controlling the on-screen keyboard, wherein the group of functions includes moving between keys within a block, selecting a key, moving between key blocks, and selecting a pre-determined group of keys in order;
in response to brain activity input, generating an electronic control signal for performing at least one pre-determined function from the group of functions; and
displaying on the on-screen keyboard a result of performing the pre-determined function.

2. The method of claim 1, wherein said brain activity input is provided by an EEG headset.

3. The method of claim 1, wherein the group of functions further includes selecting an arrow key.

4. The method of claim 1, wherein the group of functions further includes selecting a frequent use key from the frequent use key block.

5. The method of claim 1, wherein the function of selecting a pre-determined group of keys in order includes selecting at least one key that toggles between activated and deactivated states and then selecting a key corresponding to a symbol.

6. The method of claim 1, wherein the function of moving between keys within a block repeats until a key is selected.

7. The method of claim 6, wherein a rate at which the function of moving between keys repeats is adjustable.

8. A system for using thoughts or facial expressions to operate a computer, comprising:
an on-screen keyboard software module for displaying and controlling an on-screen keyboard, wherein said on-screen keyboard is arranged to include a block of at least alphabetical keys, a block of at least numerical keys, and a block of at least frequent use keys; and
an input device interface software module for generating control signals in response to detected brain activity;
wherein, in response to the control signals, said on-screen keyboard software module provides a group of pre-determined functions comprising moving between keys within a block, selecting a key, moving between key blocks, and selecting a pre-determined group of keys in order; and
wherein, in response to the control signals, said on-screen keyboard software module causes the on-screen keyboard to display a result of performing the pre-determined function.

9. The system of claim 8, wherein said input device interface software module is adapted to receive EEG data from an EEG headset.

10. The system of claim 8, wherein said pre-determined functions also include selecting an arrow key.

11. The system of claim 8, wherein said pre-determined functions also include selecting a key from the frequent use key block.

12. The system of claim 8, wherein the function of selecting a pre-determined group of keys in order includes selecting at least one key that toggles between activated and deactivated states and then selecting a key corresponding to a symbol.

13. The system of claim 8, wherein, in response to determining that the pre-determined function is to move between keys within a block, the on-screen keyboard software module continuously repeats the function of moving between keys within a block until a key is selected.

14. The system of claim 13, wherein a rate at which the on-screen keyboard software module repeats the function of moving between keys within a block is user-selectable.

15. A computer program product, stored on a computer-readable storage medium, for use for using thoughts or facial expressions to operate a computer, the computer program product comprising instructions for causing a computer to
display on an on-screen keyboard a block of at least alphabetical keys, a block of at least numerical keys, and a block of at least frequent use keys;
provide a group of functions for controlling the on-screen keyboard, wherein the group of functions includes moving between keys within a block, selecting a key, moving between key blocks, and selecting a pre-determined group of keys in order;
in response to brain activity input, generate an electronic control signal for performing at least one pre-determined function from the group of functions; and
display on the on-screen keyboard a result of performing the pre-determined function.
